(19) United States
(12) Patent Application Publication
(10) Pub. No.: US 2025/0239115 A1
(43) Pub. Date: Jul. 24, 2025

(54) SAFETY PROTECTION APPARATUS, ELECTRIFIED SYSTEM, ENERGY STORAGE SYSTEM, AND CONTROL SYSTEM

(71) Applicant: CONTEMPORARY AMPEREX TECHNOLOGY (HONG KONG) LIMITED, Hong Kong (CN)

(72) Inventors: Hongjie MIAO, Ningde (CN); Dongxu YU, Ningde (CN); Yanhua LU, Ningde (CN); Mengjia CHEN, Ningde (CN); Yongzheng YU, Ningde (CN); Liliuyuan LIANG, Ningde (CN); Tan SU, Ningde (CN); Dashuai FAN, Ningde (CN); Jianbin ZHU, Ningde (CN)

(21) Appl. No.: 19/174,616

(22) Filed: Apr. 9, 2025

Related U.S. Application Data
(63) Continuation of application No. PCT/CN2022/128697, filed on Oct. 31, 2022.

(51) Int. Cl. G07C 9/00; G08B 21/02

(52) U.S. Cl. CPC G07C 9/00174; G08B 21/02; G07C 2009/00634

(57) ABSTRACT

A safety protection apparatus comprises: a detection element configured to detect an electrical signal of an area to be detected and transmit the electrical signal to a control device, so that the control device determines the current state of the area to be detected according to the electrical signal; an alarm apparatus configured to acquire a prompt instruction from the control device to prompt the current state of the area to be detected according to the prompt instruction; and a door lock device configured to acquire an opening and closing instruction from the control device to lock or open an entrance/exit of the area to be detected according to the opening and closing instruction, wherein the opening and closing instruction is determined according to the current state.

### CROSS-REFERENCE TO RELATED APPLICATION

This application is a continuation of International Application No. PCT/CN2022/128697, filed on Oct. 31, 2022, the entire content of which is incorporated herein by reference.

### TECHNICAL FIELD

The present application relates to the technical field of safety, and in particular to safety protection apparatus, an electrified system, an energy storage system, and a control system.

### BACKGROUND

At present, some electrified places, such as DC directly-suspended energy storage systems, are a new type of energy storage apparatuses based on container structures, which can solve various transient state and steady state problems of DC systems. However, the operation and maintenance safety of this type of electrified places also needs further consideration. The particularity of such places lies in that each sub-module inside is a high-voltage active system, brackets that carry the sub-modules during the operation of the system may also be electrified bodies, and if relevant personnel accidentally enter such places during operation, there will be a risk of electric shock.

### SUMMARY

In view of this, the purposes of embodiments of the present application are to provide a safety protection apparatus, an electrified system, an energy storage system, and a control system, so as to improve the safety when entering and exiting the electrified places.

According to a first aspect, an embodiment of the present application provides a safety protection apparatus, comprising: a detection element configured to detect an electrical signal of an area to be detected and transmit the electrical signal to a control device, so that the control device determines the current state of the area to be detected according to the electrical signal; an alarm apparatus configured to acquire a prompt instruction from the control device to prompt the current state of the area to be detected according to the prompt instruction; and a door lock device configured to acquire an opening and closing instruction from the control device to lock or open an entrance/exit of the area to be detected according to the opening and closing instruction, wherein the opening and closing instruction is determined according to the current state.

In an optional embodiment, the detection element comprises a current sensor, and the current sensor is mounted at a position of a device connecting line in the area to be detected and is configured to detect current data of the device connecting line in the area to be detected.

Through the above embodiment, the current sensor can intuitively reflect whether the place is electrified, thus reflecting whether the area to be detected is safe.

In an optional embodiment, the detection element comprises a first current sensor and a second current sensor; the first current sensor is mounted at the first position of the device connecting line in the area to be detected, and the first current sensor is configured to detect first current data at the first position of the device connecting line in the area to be detected; the second current sensor is mounted at a second position of the device connecting line in the area to be detected, the second current sensor is configured to detect second current data at the second position of the device connecting line in the area to be detected, and the first position and the second position are respectively located on two sides of the area to be detected.

In the above embodiment, through two current sensors, it can detect a risk that the shell of the area to be detected is possibly electrified when a ground short-circuiting fault occurs. It can more comprehensively reflect whether the area to be detected is safe.

In an optional embodiment, the alarm apparatus comprises a light alarm apparatus, and the light alarm apparatus is configured to output light with different attributes according to the current state of the area to be detected.

In the above embodiment, light with different attributes are outputted to indicate the current state of the area to be detected to indirectly prevent relevant personnel from entering the area to be detected in an unsafe state, thus improving the safety when entering and exiting the area to be detected.

In an optional embodiment, the current state of the area to be detected is an accessible state or an inaccessible state; the alarm apparatus further comprises a sound and light alarm apparatus, and the sound and light alarm apparatus is configured to output a sound and light alarm signal when the area to be detected is in an inaccessible state and the door lock device is triggered; or the sound and light alarm apparatus is configured to output a sound and light alarm signal when the area to be detected is in an inaccessible state and a person is detected in a limited area of the area to be detected.

In the above embodiment, the sound and light alarm apparatus can output a sound and light signal to more clearly indicate the danger in the area to be detected, thus improving the safety when entering and exiting the area to be detected.

According to a second aspect, an embodiment of the present application provides an electrified system, comprising an accommodating structure, a functional device mounted in the accommodating structure, and the safety protection apparatus described above,
wherein the detection element of the safety protection apparatus is configured to detect an electrical signal of the accommodating structure;
the alarm apparatus of the safety protection apparatus is configured to indicate the current state of the accommodating structure, and the current state is determined according to the electrical signal;
the door lock device of the safety protection apparatus is configured to lock or open an entrance/exit of the accommodating structure, and the opening and closing instruction is determined according to the current state.

According to a third aspect, an embodiment of the present application provides an energy storage system, comprising a box body, an energy storage sub-module mounted in the box body, and the safety protection apparatus described above,
wherein the detection element of the safety protection apparatus is configured to detect an electrical signal of the box body;
the alarm apparatus of the safety protection apparatus is configured to indicate the current state of the box body, and the current state is determined according to the electrical signal;
the door lock device of the safety protection apparatus is configured to lock or open an entrance/exit of the box body, and the opening and closing instruction is determined according to the current state.

In an optional embodiment, the energy storage sub-module comprises a power module and a battery module;
the energy storage system further comprises a sub-module controller and a battery management unit;
the sub-module controller is configured to control on and off of the power module;
the battery management unit is configured to manage the battery module.

According to a fourth aspect, an embodiment of the present application provides a control system, comprising a control device and the safety protection apparatus described above,
wherein the detection element of the safety protection apparatus is configured to detect an electrical signal of an area to be detected and transmit the electrical signal to the control device;
the control device is configured to determine the current state of the area to be detected according to the electrical signal, and generate a prompt instruction and an opening and closing instruction according to the current state;
the alarm apparatus of the safety protection apparatus is configured to acquire the prompt instruction from the control device to prompt the current state of the area to be detected according to the prompt instruction;
the door lock device of the safety protection apparatus is configured to acquire the opening and closing instruction from the control device to lock or open the entrance/exit of the area to be detected according to the opening and closing instruction, and the opening and closing instruction is determined according to the current state.

According to a fifth aspect, an embodiment of the present application provides a control method, comprising: acquiring an electrical signal of an area to be detected; determining the current state of the area to be detected according to the electrical signal; and transmitting a control instruction to an alarm apparatus and a door lock device according to the current state, wherein the control instruction is used for controlling the alarm apparatus and the door lock device to maintain a state associated with the current state of the area to be detected.

In an optional embodiment, the electrical signal comprises current data at the entrance/exit of the area to be detected; the determining the current state of the area to be detected according to the electrical signal comprises: if the current data is not less than a set threshold, determining that the current state of the area to be detected is an inaccessible state.

In the above embodiment, by using the set threshold as the determination reference for the current data, the current state of the area to be detected can be determined, thus making the current state of the area to be detected determined more clearly and simply, and reducing the amount of calculation required for determination.

In an optional embodiment, the area to be detected is an energy storage system, and the energy storage system comprises an energy storage sub-module;
the electrical signal further comprises the number of connected relays in the energy storage sub-module in the area to be detected;
the determining the current state of the area to be detected according to the electrical signal comprises: if the number of connected relays in the energy storage sub-module is not less than one, determining that the current state of the area to be detected is an inaccessible state; and if the current data is less than a set threshold and the number of connected relays in the energy storage sub-module is less than one, determining that the current state of the area to be detected is an accessible state.

In the above embodiment, in addition to determining the current data of the area to be detected, the connection state of relays in each internal sub-system can also be determined, thus more accurately determining the current state of the area to be detected.

In an optional embodiment, the method further comprises:
if the number of connected relays in the energy storage sub-module is greater than or equal to one and the number of connected relays in the energy storage sub-module is less than N, transmitting a power-off instruction to the area to be detected, wherein the power-off instruction is used for instructing the area to be detected to disconnect the relays in each energy storage sub-module, and N represents the total number of the energy storage sub-modules in the area to be detected; and
performing the step of determining the current state of the area to be detected according to the electrical signal after the power-off instruction is transmitted.

In the above embodiment, if it is determined that the relays in some energy storage sub-modules in the area to be detected are in a connected state and the relays in some energy storage sub-modules are in a disconnected state, there is a high probability that there is an abnormality in the connection situation of the area to be detected. Therefore, in this case, before subsequent processing, a prompt can be outputted, so that the state of the area to be detected can be prompted more clearly through the alarm apparatus.

In an optional embodiment, before the determining the current state of the area to be detected according to the electrical signal, the method further comprises: acquiring the state of the door lock device for the area to be detected; and if the state of the door lock device is an open state, transmitting a danger prompt instruction to the alarm apparatus for the area to be detected, wherein the danger prompt instruction is used for instructing the alarm apparatus to output a danger prompt.

In the above embodiment, if the door lock device for the area to be detected is in an open state before determining the current state of the area to be detected, there will be a risk of mistakenly entering the area to be detected. Therefore, in this case, a danger prompt can be outputted to reduce the risk that relevant personnel mistakenly enter the area to be detected.

In an optional embodiment, the electrical signal comprises current data at the entrance/exit of the area to be detected, the number of connected relays in the energy storage sub-module in the area to be detected, and voltage data between the energy storage sub-modules;
the determining the current state of the area to be detected according to the electrical signal comprises:
if the current data is not less than a set threshold, determining that the current state of the area to be detected is an inaccessible state;
if the number of connected relays in the energy storage sub-module is not less than one, determining that the current state of the area to be detected is an inaccessible state;
if the voltage data between any two energy storage sub-modules is a non-zero value, determining that the current state of the area to be detected is an inaccessible state; and
if the current data is less than a set threshold, the number of connected relays in the energy storage sub-module is less than one, and the voltage data between any two energy storage sub-modules is zero, determining that the current state of the area to be detected is an accessible state.

In the above embodiment, the voltage data between the energy storage sub-modules can be further detected, thus further improving the comprehensiveness of the detection result.

In a sixth aspect, an embodiment of the present application provides a control device, comprising a processor and a memory, wherein the memory stores machine-readable instructions executable by the processor, and when the control device runs, the machine-readable instructions are executed by the processor to perform the steps of the method described above.

The safety protection apparatus, electrified system, energy storage system, and control system provided in embodiments of the present application can identify the current state of the area to be detected to determine whether the area to be detected is accessible, and control the state of the alarm apparatus and the door lock device for the area to be detected, thus improving the safety when entering and exiting the area to be detected.

In order to make the above purposes, features, and advantages of the present application clearer and more understandable, detailed description will be made below through the following given embodiments with reference to the drawings.

### DESCRIPTION OF DRAWINGS

To more clearly describe the technical solutions of the embodiments of the present application, the drawings to be used in the embodiments of the present application will be briefly introduced below, and it should be understood that the following drawings only illustrate some embodiments of the present application, and thus should not be considered as limiting the scope. For those skilled in the art, other relevant drawings may also be obtained based on these drawings without contributing any inventive labor.

FIG. 1 is a schematic diagram of interaction between an area to be detected and a control device according to an embodiment of the present application.

FIG. 2 is a schematic structural diagram of an area to be detected mounted with a safety protection apparatus according to an embodiment of the present application.

FIG. 3 is a schematic circuit diagram of an energy storage system according to an embodiment of the present application.

FIG. 4 is a schematic circuit diagram of an energy storage sub-module of an energy storage system according to an embodiment of the present application.

FIG. 5 is a schematic block diagram of a control device according to an embodiment of the present application.

FIG. 6 is a flowchart of a control method according to an embodiment of the present application.

Description of reference signs: 100—area to be detected; 110—safety protection apparatus; 111—detection element; 112—alarm apparatus; 113—door lock device; 114—device connecting line; 121—first entrance/exit; 122—second entrance/exit; 130—transmitting end circulation station; 140—receiving end circulation station; 150—energy storage sub—module; 151—battery; IGBT1—first insulated gate bipolar transistor; IGBT2—second insulated gate bipolar transistor; C—filter capacitor; 200—control device; 211—memory; 213—processor

### DETAILED DESCRIPTION

The technical solutions in the embodiments of the present application will be described below with reference to the drawings in the embodiments of the present application.

It should be noted that similar designations and letters represent similar terms in the drawings below, so once a certain item is defined in a drawing, it does not need to be further defined and explained in subsequent drawings. Further, in the description of the present application, the terms such as “first” and “second” are only intended to distinguish the description, and cannot be understood as indicating or implying relative importance.

Some high-voltage electrified places can be well applied in various scenarios. For example, DC directly-suspended energy storage systems are a new type of energy storage apparatuses based on container structures, which can solve various transient state and steady state problems of DC systems.

However, it also introduces some problems. The particularity of such places lies in the that sub-modules inside are all high-voltage active systems, brackets that carry the internal sub-modules in these high-voltage electrified places may also be electrified bodies during operation, and if relevant personnel accidentally enter the operating container, there will be a risk of electric shock. When a ground short-circuiting fault occurs in the system, there will be a risk that the shell of the container is also electrified. Therefore, the operation and maintenance safety of such high-voltage electrified places needs to be further considered. Under normal circumstances, when a high-voltage electrified area stops operating, maintenance personnel need to enter the container for inspection, and cannot immediately determine whether the shell of the container is electrified or whether there is a risk of ground short-circuiting inside the container.

In view of the above situation, the present application provides a safety protection apparatus 110, an electrified system, an energy storage system, a control system, and a control method, which can detect the current state of the high-voltage electrified place to determine whether the high-voltage electrified place is safe. After determining that it is safe, relevant personnel are allowed to enter and exit the high-voltage electrified place.

The safety protection apparatus 110 and the control method provided in this embodiment can be used in any high-voltage electrified environment, such as energy storage systems and data centers.

To facilitate understanding of this embodiment, the operating environment of a control method disclosed in an embodiment of the present application is introduced firstly.

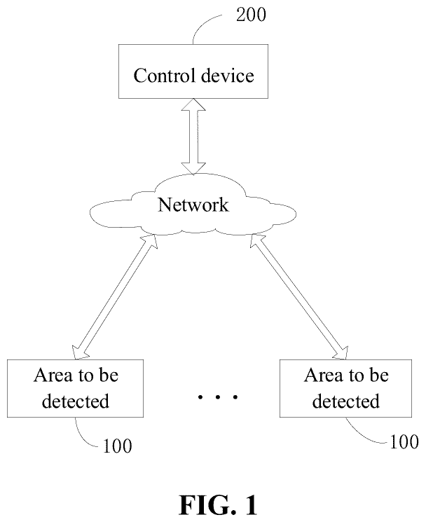

FIG. 1 is a schematic diagram of interaction between an area to be detected 100 and a control device 200 according to an embodiment of the present application. The control device 200 is in communicative connection with one or more areas to be detected 100 through a network to achieve data communication or interaction. The control device 200 may be a network server, a database server or the like, or may be a Personal Computer (PC), a tablet, a smart phone, a Personal Digital Assistant (PDA), an upper computer, or the like.

The area to be detected 100 may be any place with a high-voltage electrified device operating inside. An area that accommodates the high-voltage electrified device may be made of a conductive material. For example, it may be a metal shell, container, or the like.

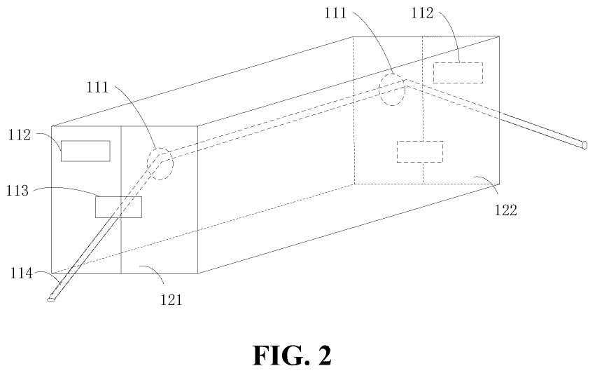

In this embodiment, a safety protection apparatus 110 is mounted in the area to be detected 100. Referring to FIG. 2, the safety protection apparatus 110 comprises a detection element 111, an alarm apparatus 112, and a door lock device 113.

The detection element 111 may be configured to detect an electrical signal of the area to be detected 100. The electrical signal may be transmitted to the control device 200, so that the control device 200 determines the current state of the area to be detected 100 according to the electrical signal.

The alarm apparatus 112 may acquire a prompt instruction from the control device 200 to prompt the current state of the area to be detected 100 according to the prompt instruction.

Exemplarily, the current state of the area to be detected 100 may be an accessible state or an inaccessible state. The current state of the area to be detected 100 may also be one of a safe state, a risk state, or other states.

The door lock device 113 may acquire an opening and closing instruction from the control device 200 to lock or open the entrance/exit of the area to be detected 100 according to the opening and closing instruction. The opening and closing instruction may be determined according to the current state of the area to be detected 100.

Exemplarily, when the current state of the area to be detected 100 is an accessible state or a safe state and it indicates that the environment of the area to be detected 100 is suitable for relevant personnel to enter and exit, it may be determined that the opening and closing instruction is used for instructing the door lock device 113 to be in an open state or in an openable state.

Exemplarily, when the current state of the area to be detected 100 is an inaccessible state or a risk state and it indicates that the environment of the area to be detected 100 is not suitable for relevant personnel to enter and exit, it may be determined that the opening and closing instruction is used for instructing the door lock device 113 to be in a closed state or in a non-openable state.

In this embodiment, the door lock device 113 may be a controllable door lock, and the door lock device 113 mounted in the area to be detected 100 can be controlled to be opened or closed according to the instruction from the control device 200. Exemplarily, the door lock device 113 may have a limiting function, that is, when the control device 200 opens the door lock device 113, the door in the area to be detected 100 is still closed and will not automatically open. It needs to be manually opened, so that the door lock device 113 can be fully opened and the door in the area to be detected 100 can be opened.

The control device 200 may be an electronic device mounted inside or around the area to be detected 100. The electronic device has a processing function. The processing function may perform computing according to the obtained electrical signal to obtain a prompt instruction or an opening and closing instruction, and transmit the prompt instruction to the alarm apparatus 112 and the opening and closing instruction to the door lock device 113.

The control device 200 may also be a backend server in connection with each area to be detected 100. The backend server may receive the electrical signal transmitted by each area to be detected 100 to determine the current state of each area to be detected 100.

In the above embodiment, the current state of the area to be detected 100 can be identified to determine whether the area to be detected 100 is accessible, and control the state of the alarm apparatus 112 and the door lock device 113 in the area to be detected 100, thus improving the safety when entering and exiting the area to be detected 100.

Optionally, the safety protection apparatus 110 may also be provided with a communication unit, the communication unit may be configured to communicate with the control device 200, so as to transmit the electrical signal of the area to be detected 100, and receive the opening and closing instruction transmitted by the control device 200.

In an embodiment, the current state of the area to be detected 100 may be determined by detecting whether there is current in a connecting line between devices in the area to be detected 100. The detection element 111 comprises a current sensor.

The current sensor may be mounted at a position of a device connecting line 114 in the area to be detected 100 to detect current data of the device connecting line 114 in the area to be detected 100.

Optionally, the device connecting line 114 may be a cable for connecting various devices in the area to be detected 100. For example, the cable may be a DC cable.

By detecting the current of the device connecting line 114 in the area to be detected 100, it can be determined whether the devices connected by the device connecting line 114 in the area to be detected 100 are in an operating state. If they are in an operating state, it may cause the devices in the area to be detected 100 to be electrified, and the accommodating area where various devices are accommodated may also be electrified. Therefore, the current state of the area to be detected 100 may be determined by detecting whether there is current on the device connecting line 114.

When a ground short-circuiting fault occurs in the area to be detected 100, there will be a risk that the shell of the area to be detected 100 is possibly electrified. When a ground short-circuiting fault occurs in the area to be detected 100, the current data at some positions of the device connecting line 114 may be zero, and the current data at some positions may be non-zero. Based on this characteristic, multiple current sensors may be mounted at multiple positions of the device connecting line 114.

In an embodiment, the detection element 111 comprises a first current sensor and a second current sensor.

Optionally, the first current sensor is mounted at the first position of the device connecting line 114 in the area to be detected 100, and the first current sensor is configured to detect first current data at the first position of the device connecting line 114 in the area to be detected 100.

Optionally, the second current sensor is mounted at a second position of the device connecting line 114 in the area to be detected 100, and the second current sensor is configured to detect second current data at the second position of the device connecting line 114 in the area to be detected 100.

The first position and the second position are respectively located on two sides of the area to be detected 100.

Exemplarily, referring to FIG. 2, the first position may be located at a first entrance/exit 121 of the area to be detected 100, and the second position may be located at a second entrance/exit 122 of the area to be detected 100.

Optionally, if the area to be detected 100 has only one entrance/exit, the first position may be located at the entrance/exit of the area to be detected 100, and the second position may be located on an outer side of a plane parallel to the plane where the entrance/exit is located.

In this embodiment, the current sensor mounted at the position of the device connecting line 114 may be a Hall sensor.

According to the actual needs, more current sensors may also be arranged in the area to be detected 100 to more accurately detect the state in the area to be detected 100.

By arranging the current sensors in the area to be detected 100, risks in the area to be detected 100 can be detected, thus improving the safety when entering and exiting the area to be detected 100.

In order to facilitate relevant users to intuitively understand whether the area to be detected 100 is safe or not, different alarm methods may be used to prompt users.

In an optional embodiment, the alarm apparatus 112 comprises a light alarm apparatus, and the light alarm apparatus is configured to output light with different attributes according to the current state of the area to be detected 100.

Exemplarily, the number of attributes of the light may be set according to the possible state of the area to be detected 100.

For example, if the number of the states of the area to be detected 100 is two, then the number of attributes of the light may also be two.

Exemplarily, the states of the area to be detected 100 comprises an accessible state and an inaccessible state. The accessible state corresponds to the light with a first attribute, and the inaccessible state corresponds to the light with a second attribute.

In an example, the light with the first attribute may be green light, and the light with the second attribute may be red light.

In another example, the light with the first attribute may be normally-on green light, and the light with the second attribute may be flashing red light.

Of course, if there are more states of the area to be detected 100, light with more attributes may be configured according to the number of states of the area to be detected 100 to achieve more accurate prompt of the states of the area to be detected 100.

Exemplarily, the current state of the area to be detected 100 is an accessible state or an inaccessible state; the alarm apparatus 112 may further comprise a sound and light alarm apparatus.

The sound and light alarm apparatus may determine different output prompts according to different states of the area to be detected 100.

Exemplarily, when the current state of the area to be detected 100 is an accessible state, the sound and light alarm apparatus may be in an off state. Exemplarily, when the current state of the area to be detected 100 is an inaccessible state, the sound and light alarm apparatus may output one of a light prompt, a sound prompt, and a combination thereof.

In an embodiment, the sound and light alarm apparatus is configured to output a sound and light alarm signal when the area to be detected 100 is in an inaccessible state and the door lock device 113 is triggered.

In an embodiment, the sound and light alarm apparatus is configured to output a sound and light alarm signal when the area to be detected 100 is in an inaccessible state and a person is detected in a limited area of the area to be detected 100.

Optionally, an acquisition device may be arranged around the area to be detected 100, the acquisition device may be configured to acquire image data around the area to be detected 100, and the control device 200 can determine whether there is a person around the area to be detected 100 according to the image data.

The safety protection apparatus 110 may be used in different areas to be detected 100. For example, the area to be detected 100 may be a place where multiple high-voltage electrified devices are operating.

Therefore, an embodiment of the present application further provides an electrified system. The electrified system may comprise an accommodating structure, a functional device mounted in the accommodating structure, and the safety protection apparatus 110 described above,

The detection element 111 of the safety protection apparatus 110 is configured to detect an electrical signal of the accommodating structure; the alarm apparatus 112 of the safety protection apparatus 110 is configured to indicate the current state of the accommodating structure, and the current state is determined according to the electrical signal; the door lock device 113 of the safety protection apparatus 110 is configured to lock or open an entrance/exit of the accommodating structure, and the opening and closing instruction is determined according to the current state.

The accommodating structure may be a container structure.

The functional device mounted in the accommodating structure may be a device that provides services for the electrified system. For example, the functional device may be a device that provides services for the electrified system. For example, the functional device may be a computer, a service program may run in the computer, and the service program, when running, may provide needed function for the electrified service.

For other details about the safety protection apparatus 110 in this embodiment, please refer to the description in the embodiment of the safety protection apparatus 110, which will not be repeated here.

An embodiment of the present application further provides an energy storage system. The energy storage system may comprise a box body, an energy storage sub-module 150 mounted in the box body, and the safety protection apparatus 110 described above,

The detection element 111 of the safety protection apparatus 110 is configured to detect an electrical signal of the box body; the alarm apparatus 112 of the safety protection apparatus 110 is configured to indicate the current state of the box body, and the current state is determined according to the electrical signal; the door lock device 113 of the safety protection apparatus 110 is configured to lock or open an entrance/exit of the box body, and the opening and closing instruction is determined according to the current state.

Exemplarily, the box body may be a container. The box body may also be any box body capable of carrying reach energy storage sub-module 150, and a metal bracket exists in the box body.

In this embodiment, the energy storage sub-module 150 comprises a power module and a battery 151 module. The energy storage system further comprises a sub-module controller and a battery 151 management unit. The sub-module controller is configured to control on and off of the power module. The battery 151 management unit is configured to manage the battery 151 module.

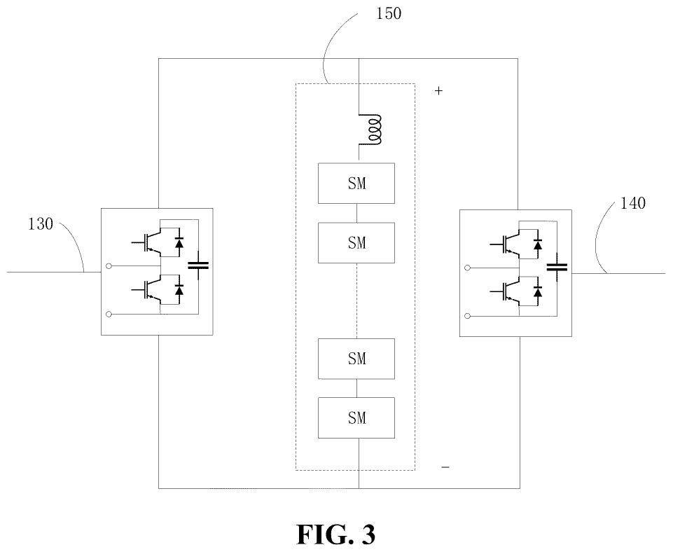

Exemplarily, the energy storage system may be a novel high-voltage directly-suspended energy storage system. Referring to FIG. 3, the energy storage system may comprise multiple energy storage sub-modules 150 connected to DC sides of two ends of a transmitting end circulation station 130 and a receiving end circulation station 140, which are connected in series to form a novel directly-suspended energy storage system. Exemplarily, the energy storage system may further comprise a reactor. The reactor is connected in series with each energy storage sub-module 150 to form a novel directly-suspended energy storage system.

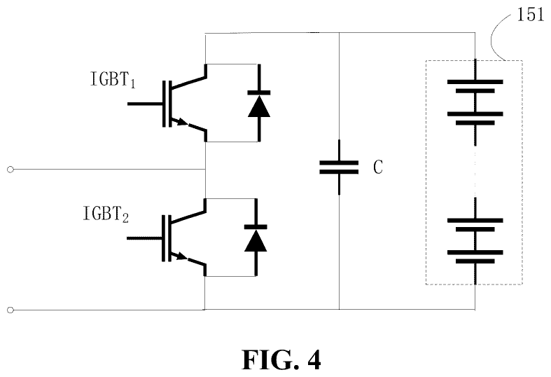

In this embodiment, referring to FIG. 4, the energy storage sub-module 150 may be composed of a half bridge circuit formed by two series Insulated Gate Bipolar Transistors (IGBTs), a filter capacitor C, a filter reactor, and a battery 151. The half bridge circuit formed by the two series IGBTs, namely a first insulated gate bipolar transistor IGBT1 and a second insulated gate bipolar transistor IGBT2, may be the power module.

In this embodiment, the IGBTs in the power module may be controlled to be on and off through the Sub-Module Controller (SMC).

In this embodiment, signals of the battery 151 may be acquired by a battery 151 management unit (Battery Management System). The battery 151 management unit may acquire signals such as current and voltage of the battery 151, and may also control the disconnection of high-voltage DC relays in the battery 151 module.

The battery 151 management unit may communicate with the sub-module controller through optical fibers, be managed by the sub-module controller, receive instructions from the sub-module controller, and upload information about the battery 151 to the sub-module controller.

For other details about the safety protection apparatus 110 in this embodiment, please refer to the description in the embodiment of the safety protection apparatus 110, which will not be repeated here.

By mounting the safety protection apparatus 110 in the energy storage system, whether the state of the energy storage system is safe can be determined, thus reducing the risk of the energy storage system and improving the safety when entering and exiting the energy storage system.

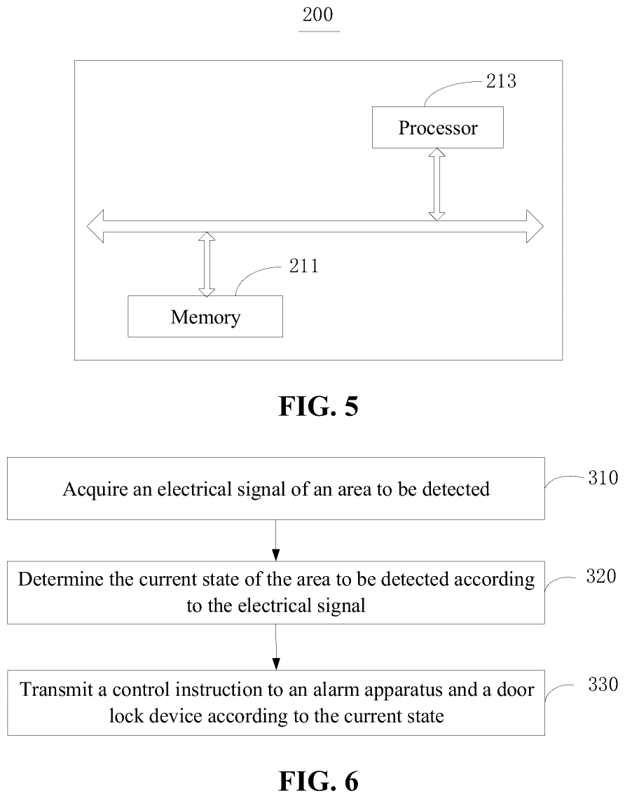

An embodiment of the present application further provides a control device 200. Referring to FIG. 5, it is a schematic block diagram of the control device 200. The control device 200 may comprise a memory 211 and a processor 213. Those skilled in the art may understand that the structure shown in FIG. 5 is only schematic and does not limit the structure of the control device 200. For example, the control device 200 may further comprise more or fewer components than in FIG. 5, or may have a configuration different from that in FIG. 5.

The memory 211 and the processor 213 are directly or indirectly electrically connected with each other to achieve data transmission or interaction. For example, the components may be electrically connected with each other through one or more communication buses or signal lines. The processor 213 is configured to execute an executable module stored in the memory.

The memory 211 may be, but not limited to, a Random Access Memory (RAM), a Read-Only Memory (ROM), a Programmable Read-Only Memory (PROM), an Erasable Programmable Read-Only Memory (EPROM), or an Electric Erasable Programmable Read-Only Memory (EEPROM). The memory 211 is configured to store a program. The processor 213 executes the program after receiving an execution instruction. The method executed by the control device 200 as defined by the process disclosed in any embodiment of the present application may be applied to the processor 213 or realized by the processor 213.

The processor 213 may be an integrated circuit chip with signal processing capabilities. The processor 213 may be a general-purpose processor, comprising a Central Processing Unit (CPU), and a Network Processor (NP), or the like; or may be a Digital Signal Processor (DSP), an Application Specific Integrated Circuit (ASIC), a Field Programmable Gate Array (FPGA) or any other programmable logic device, a discrete gate or transistor logic device, or a discrete hardware component. It can implement or execute various methods, steps and logical block diagrams disclosed in the embodiments of the present application. The general-purpose processor may be a microprocessor or the processor may also be any conventional processor.

In this embodiment, the control device 200 may be configured to execute each step in each method provided in the embodiments of the present application. The implementation process of the control method will be described in detail below through several embodiments.

Please refer to FIG. 6, it is a flowchart of a control method according to an embodiment of the present application. The steps of the method in this embodiment may be performed by the control device in FIG. 5. The specific process shown in FIG. 6 will be described in detail below.

In step 310, an electrical signal of an area to be detected is acquired.

Exemplarily, the electrical signal may be obtained through detection by a sensor mounted in the area to be detected.

Exemplarily, the electrical signal may also be determined according to the working state of a functional device in the area to be detected. For example, the electrical signal may be determined according to whether the functional device in the area to be detected is in a power-on state.

In step 320, the current state of the area to be detected is determined according to the electrical signal.

The electrical signal may be a signal for representing whether the area to be detected is electrified. For example, the electrical signal may be current data.

Exemplarily, whether the area to be detected is electrified may be determined according to the electrical signal. If the area to be detected is electrified, it indicates that the area to be detected is not suitable for personnel to enter and exit; if the area to be detected is not electrified, it indicates that personnel are allowed to enter and exit the area to be detected.

In step 330, a control instruction is transmitted to an alarm apparatus and a door lock device according to the current state.

The control instruction is used for controlling the alarm apparatus and the door lock device to maintain a state associated with the current state of the area to be detected.

Exemplarily, different current states may correspond to different control instructions. Different control instructions may be used for instructing the alarm apparatus and the door lock device to present different states.

Optionally, the control instruction may comprise an opening and closing instruction for controlling the opening or closing of the door lock device. Exemplarily, if the current state of the area to be detected is an accessible state, the opening and closing instruction may instruct the door lock device to open, or instruct the door lock device to be in an openable state. Exemplarily, if the current state of the area to be detected is an inaccessible state, the opening and closing instruction may instruct the door lock device to close, or instruct the door lock device to be in a locked state.

Optionally, the control instruction may comprise a prompt instruction for controlling the alarm apparatus to output a state prompt for the area to be detected. Exemplarily, if the current state of the area to be detected is an accessible state, the prompt instruction may instruct the alarm apparatus to give no output, or instruct the alarm apparatus to output an alarm corresponding to the state. Exemplarily, if the current state of the area to be detected is an inaccessible state, the prompt instruction may instruct the alarm apparatus to output a risk prompt.

In an embodiment, the electrical signal comprises current data at the entrance/exit of the area to be detected. Based on this, step 320 may comprise: if the current data is not less than a set threshold, determining that the current state of the area to be detected is an inaccessible state.

The set threshold may be a small value. For example, the set threshold may be 0.1 A, 0.2 A, or the like.

Exemplarily, if multiple positions in the area to be detected are provided with current sensors, multiple current data of the area to be detected may be obtained; and if any current data is not less than the set threshold, it is determined that the current state of the area to be detected is an inaccessible state.

In an embodiment, the area to be detected is an energy storage system, and the energy storage system comprises an energy storage sub-module. The electrical signal further comprises the number of connected relays in the energy storage sub-module in the area to be detected. Step 320 may comprise: if the number of connected relays in the energy storage sub-module is not less than one, determining that the current state of the area to be detected is an inaccessible state; and if the current data is less than a set threshold and the number of connected relays in the energy storage sub-module is less than one, determining that the current state of the area to be detected is an accessible state.

Exemplarily, if the energy storage system comprises N energy storage sub-modules, all relays in each energy storage sub-module of the N energy storage sub-modules are in a disconnected state and all collected current data are less than the set threshold, it may be determined that the current state of the area to be detected is an accessible state.

Exemplarily, if the energy storage system comprises N energy storage sub-modules and one of relays in each energy storage sub-module of the N energy storage sub-modules is in a connected state, or any current data is not less than the set threshold, it may be determined that the current state of the area to be detected is an inaccessible state.

In this embodiment, if relays of some energy storage sub-modules of the N energy storage sub-modules are in a connected state, and if relays of the other energy storage sub-modules of the N energy storage sub-modules are in a disconnected state, there may be two situations: one situation is that the relays of some storage sub-modules or the storage sub-modules have a fault, and the other situation is that the battery management units in some storage sub-modules are not successfully disconnected from a circuit breaker connected with the sub-module controller.

Based on this, in this embodiment, the control method may further comprise: if the number of connected relays in the energy storage sub-module is greater than or equal to one and the number of connected relays in the energy storage sub-module is less than N, transmitting a power-off instruction to the area to be detected.

The power-off instruction is used for instructing the area to be detected to disconnect the relays in each energy storage sub-module, and N represents the total number of the energy storage sub-modules in the area to be detected.

After the power-off instruction is transmitted, step 320 is performed to determine the current state of the area to be detected.

If the number of connected relays in the energy storage sub-module is equal to N, it may be determined that each relay in each energy storage sub-module in the area to be detected is in a connected state, so it is not suitable for personnel to enter the area to be detected, and it is determined that the current state of the area to be detected is an inaccessible state.

Optionally, if the number of connected relays in the energy storage sub-module is greater than or equal to one and the number of connected relays in the energy storage sub-module is less than N, a prompt message may also be transmitted to relevant personnel. The prompt message is used for prompting relevant personnel about the connection or disconnection situation of the relays in the energy storage sub-module, so that the relevant personnel can know the situation of the energy storage system.

In order to reduce the risk of the area to be detected, before the current state of the area to be detected is determined through the electrical signal, the state of the door lock device for the area to be detected may be determined firstly. Therefore, before step 320, the control method further comprises: acquiring the state of the door lock device for the area to be detected; and if the state of the door lock device is an open state, transmitting a danger prompt instruction to the alarm apparatus for the area to be detected, wherein the danger prompt instruction is used for instructing the alarm apparatus to output a danger prompt.

Exemplarily, a sound and light signal may be outputted through a sound and light alarm apparatus in the alarm apparatus to prompt relevant users about a potential risk in the area to be detected.

In this embodiment, the electrical signal of the area to be detected comprises current data at the entrance/exit of the area to be detected, the number of connected relays in the energy storage sub-module in the area to be detected, and voltage data between the energy storage sub-modules. Based on this, step 320 may comprise:
if the current data is not less than a set threshold, determining that the current state of the area to be detected is an inaccessible state;
if the number of connected relays in the energy storage sub-module is not less than one, determining that the current state of the area to be detected is an inaccessible state;
if the voltage data between any two energy storage sub-modules is a non-zero value, determining that the current state of the area to be detected is an inaccessible state; and
if the current data is less than a set threshold, the number of connected relays in the energy storage sub-module is less than one, and the voltage data between any two energy storage sub-modules is zero, determining that the current state of the area to be detected is an accessible state.

Optionally, if any current data is not less than a set threshold, it may be determined that the current state of the area to be detected is an inaccessible state.

Optionally, if the number of connected relays in the energy storage sub-module is greater than or equal to one, it may also be determined that the current state of the area to be detected is an inaccessible state.

Optionally, if the voltage data between any two energy storage sub-modules is not zero, it may also be determined that the current state of the area to be detected is an inaccessible state.

The whole process of the control method will be described below by taking the area to be detected being an energy storage system mounted in the form of a container as an example.

Before the current state of the area to be detected is determined, a power-off instruction may be firstly transmitted to the area to be detected. If the area to be detected is a large system comprising multiple containers and energy storage systems, the storage systems formed by each container may be disconnected from each other through the power-off instruction, and then the relay between the battery management unit and the sub-module controller of the energy storage sub-system in each container is disconnected.

Then whether the door lock device of each container is in a closed state is determined. If it is in a closed state, the subsequent process of determining the electrical signal of the container is performed. If it is not in a closed state, a risk prompt instruction is transmitted to the alarm apparatus. After a risk prompt is outputted, the subsequent process of determining the state of the container is performed.

The current data of a Hall sensor mounted in the container is acquired, and whether the current data is less than the set threshold is determined.

State signals of relays between the battery management unit and the sub-module controller in the container are acquired, and whether the number of relays connected at current is zero is determined.

If the current data is less than a set threshold and the number of relays connected between the battery management unit and the sub-module controller is zero, the door lock device of the container may be controlled to open.

If any current data is not less than the set threshold or the number of relays connected between the battery management unit and the sub-module controller is not zero, no personnel are allowed to enter the container.

If the number of relays connected between the battery management unit and the sub-module controller is not zero and is less than the number of relays between each battery management unit and each sub-module controller in the container, it is needed to determine whether there is a relay fault; a power-off instruction may also be transmitted to the container to control the relays between each battery management unit and each sub-module controller to be disconnected. If it is determined that there is a relay fault, a prompt instruction may also be transmitted to the alarm apparatus to indicate the relay fault through the alarm apparatus.

Through the method provided in the embodiment of the present application, the safety of the area to be detected can be determined before entering or exiting the area to be detected, the door of the area to be detected can be controlled to open after confirming that it is safe, and if it is determined that there is a risk in the area to be detected, relevant personnel are not allowed to enter, thus improving the safety when entering and exiting the area.

In addition, an embodiment of the present application further provides a computer-readable storage medium, the computer-readable storage medium stores a computer program, and the computer program, when run by the processor, executes the steps of the control method described in the method embodiment.

An embodiment of the present application further provides a computer program product of the control method, the computer program product comprises a computer-readable storage medium storing a program code, and instructions comprised in the program code may be used for performing the steps of the control method described in the method embodiment. For details, please refer to the method embodiment, which will not be repeated here.

It should be understood that the apparatus and the method disclosed in the several embodiments of the present application may also be implemented by other approaches. The apparatus embodiments described above are only illustrative. For example, the flow charts and block diagrams in the figures show the architectures, functions, and operations of possible implementations of the apparatus, the method, and the computer program product according to various embodiments of the present application. In this regard, each of the blocks in the flow charts or block diagrams may represent a module, a program segment, or a code portion, the module, the program segment, or the code portion comprising one or more executable instructions for implementing specified logic functions. It should also be noted that, in some alternative implementations, functions annotated in the blocks may also occur in a sequence different from the sequence annotated in the figures. For example, two successive blocks may actually be executed substantially in parallel, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented using a combination of special hardware and computer instructions.

In addition, each functional module in each embodiment of the present application can be integrated together to form an independent part, each module can exist alone, or two or more than two modules can be integrated to form an independent part.

The function may be stored in a computer-readable storage medium when it is implemented in the form of a software functional module and is sold or used as a separate product. Based on such understanding, the technical solutions of the present application essentially, or the part of the technical solutions, may be embodied in the form of a software product which is stored in a storage medium and comprises some instructions for causing a computer device (which may be, e.g., a personal computer, a server, or a network device) to perform all or some of the steps of the method according to the embodiments of the present application. The above storage medium comprises: various mediums that can store a program code, such as a U disk, a mobile hard disk, a read-only memory (ROM), a random access memory (RAM), a magnetic disk, or an optical disk. It should be noted that relational terms such as “first” and “second” are only used to distinguish one entity or operation from another entity or operation, and do not necessarily require or imply existence of any actual relationship or sequence between these entities or operations. Further, the terms such as “comprising”, “including” or any other variation thereof are intended to encompass non-exclusive inclusions, such that a process, a method, an article, or a device that comprises a series of elements not only comprises those elements, but also comprises other elements that are not explicitly listed, or further comprises elements that are inherent to such a process, a method, an article, or a device. In case of no more constraints, an element defined by the wording “comprise . . . ” does not preclude the existence of additional identical elements in a process, a method, an article, or a device that comprises the element.

The above description merely provides some embodiments of the present application and are not intended to limit the present application. For those skilled in the art, the present application may have various modifications and alterations. Any modification, equivalent replacement, improvement, and the like made within the spirit and principle of the present application should be encompassed within the scope of protection of the present application. It should be noted that similar designations and letters represent similar terms in the drawings below, so once a certain item is defined in a drawing, it does not need to be further defined and explained in subsequent drawings.

While the above description merely provides specific embodiments of the present application, the scope of protection of the present application is not limited to the specific embodiments. Any person skilled in the art can easily conceive of alterations or replacements within the technical scope disclosed in the present application. All these alterations or replacements should be encompassed within the scope of protection of the present application. Therefore, the scope of protection of the present application shall be determined by the scope of protection of the claims.

What is claimed is:

1. A safety protection apparatus, comprising:
a detection element configured to detect an electrical signal of an area to be detected and transmit the electrical signal to a control device, so that the control device determines the current state of the area to be detected according to the electrical signal;
an alarm apparatus configured to acquire a prompt instruction from the control device to prompt the current state of the area to be detected according to the prompt instruction; and
a door lock device configured to acquire an opening and closing instruction from the control device to lock or open an entrance/exit of the area to be detected according to the opening and closing instruction, wherein the opening and closing instruction is determined according to the current state.

2. The apparatus according to claim 1, wherein the detection element comprises a current sensor, and the current sensor is mounted at a position of a device connecting line in the area to be detected and is configured to detect current data of the device connecting line in the area to be detected.

3. The apparatus according to claim 2, wherein:
the detection element comprises a first current sensor and a second current sensor;
the first current sensor is mounted at the first position of the device connecting line in the area to be detected, and the first current sensor is configured to detect first current data at the first position of the device connecting line in the area to be detected; and
the second current sensor is mounted at a second position of the device connecting line in the area to be detected, the second current sensor is configured to detect second current data at the second position of the device connecting line in the area to be detected, and the first position and the second position are respectively located on two sides of the area to be detected.

4. The apparatus according to claim 1, wherein the alarm apparatus comprises a light alarm apparatus, and the light alarm apparatus is configured to output light with different attributes according to the current state of the area to be detected.

5. The apparatus according to claim 1, wherein:
the current state of the area to be detected is an accessible state or an inaccessible state; and
the alarm apparatus further comprises a sound and light alarm apparatus, and the sound and light alarm apparatus is configured to output a sound and light alarm signal when:
the area to be detected is in an inaccessible state, and
the door lock device is triggered or a person is detected in a limited area of the area to be detected.

6. An electrified system, comprising an accommodating structure, a functional device mounted in the accommodating structure, and the safety protection apparatus according to claim 1, wherein:
the detection element of the safety protection apparatus is configured to detect an electrical signal of the accommodating structure;
the alarm apparatus of the safety protection apparatus is configured to indicate the current state of the accommodating structure, and the current state is determined according to the electrical signal; and
the door lock device of the safety protection apparatus is configured to lock or open an entrance/exit of the accommodating structure, and the opening and closing instruction is determined according to the current state.

7. An energy storage system, comprising a box body, an energy storage sub-module mounted in the box body, and the safety protection apparatus according to claim 1, wherein:
the detection element of the safety protection apparatus is configured to detect an electrical signal of the box body;
the alarm apparatus of the safety protection apparatus is configured to indicate the current state of the box body, and the current state is determined according to the electrical signal; and
the door lock device of the safety protection apparatus is configured to lock or open an entrance/exit of the box body, and the opening and closing instruction is determined according to the current state.

8. The energy storage system according to claim 7, wherein:
the energy storage sub-module comprises a power module and a battery module;
the energy storage system further comprises a sub-module controller and a battery management unit;
the sub-module controller is configured to control on and off of the power module; and
the battery management unit is configured to manage the battery module.

9. A control system, comprising a control device and the safety protection apparatus according to claim 1, wherein:
the detection element of the safety protection apparatus is configured to detect an electrical signal of an area to be detected and transmit the electrical signal to the control device;
the control device is configured to determine the current state of the area to be detected according to the electrical signal, and generate a prompt instruction and an opening and closing instruction according to the current state;
the alarm apparatus of the safety protection apparatus is configured to acquire the prompt instruction from the control device to prompt the current state of the area to be detected according to the prompt instruction; and
the door lock device of the safety protection apparatus is configured to acquire the opening and closing instruction from the control device to lock or open the entrance/exit of the area to be detected according to the opening and closing instruction, and the opening and closing instruction is determined according to the current state.

10. A control method, comprising:
acquiring an electrical signal of an area to be detected;
determining the current state of the area to be detected according to the electrical signal; and
transmitting a control instruction to an alarm apparatus and a door lock device according to the current state, wherein the control instruction is used for controlling the alarm apparatus and the door lock device to maintain a state associated with the current state of the area to be detected.

11. The method according to claim 10, wherein:
the electrical signal comprises current data at the entrance/exit of the area to be detected; and
determining the current state of the area to be detected according to the electrical signal comprises:
if the current data is not less than a set threshold, determining that the current state of the area to be detected is an inaccessible state.

12. The method according to claim 11, wherein:
the area to be detected is an energy storage system, and the energy storage system comprises an energy storage sub-module;
the electrical signal further comprises the number of connected relays in the energy storage sub-module in the area to be detected; and
determining the current state of the area to be detected according to the electrical signal comprises:
if the number of connected relays in the energy storage sub-module is not less than one, determining that the current state of the area to be detected is an inaccessible state; and
if the current data is less than a set threshold and the number of connected relays in the energy storage sub-module is less than one, determining that the current state of the area to be detected is an accessible state.

13. The method according to claim 12, further comprising:
if the number of connected relays in the energy storage sub-module is greater than or equal to one and the number of connected relays in the energy storage sub-module is less than N, transmitting a power-off instruction to the area to be detected, wherein the power-off instruction is used for instructing the area to be detected to disconnect the relays in each energy storage sub-module, and N represents the total number of the energy storage sub-modules in the area to be detected; and
performing the step of determining the current state of the area to be detected according to the electrical signal after the power-off instruction is transmitted.

14. The method according to claim 10, further comprising, before determining the current state of the area to be detected according to the electrical signal:
acquiring the state of the door lock device for the area to be detected; and
if the state of the door lock device is an open state, transmitting a danger prompt instruction to the alarm apparatus for the area to be detected, wherein the danger prompt instruction is used for instructing the alarm apparatus to output a danger prompt.

15. The method according to claim 14, wherein:
the electrical signal comprises current data at the entrance/exit of the area to be detected, the number of connected relays in the energy storage sub-module in the area to be detected, and voltage data between the energy storage sub-modules; and
determining the current state of the area to be detected according to the electrical signal comprises:
if the current data is not less than a set threshold, determining that the current state of the area to be detected is an inaccessible state;
if the number of connected relays in the energy storage sub-module is not less than one, determining that the current state of the area to be detected is an inaccessible state;
if the voltage data between any two energy storage sub-modules is a non-zero value, determining that the current state of the area to be detected is an inaccessible state; and
if the current data is less than a set threshold, the number of connected relays in the energy storage sub-module is less than one, and the voltage data between any two energy storage sub-modules is zero, determining that the current state of the area to be detected is an accessible state.

16. A control device, comprising a processor and a memory, wherein the memory stores machine-readable instructions executable by the processor, and when the control device runs, the machine-readable instructions are executed by the processor to perform the method according to claim 10.

17. The control device according to claim 16, wherein the detection element comprises a current sensor, and the current sensor is mounted at a position of a device connecting line in the area to be detected and is configured to detect current data of the device connecting line in the area to be detected.

18. The control method according to claim 17, wherein the detection element comprises a first current sensor and a second current sensor;
the first current sensor is mounted at the first position of the device connecting line in the area to be detected, and the first current sensor is configured to detect first current data at the first position of the device connecting line in the area to be detected; and
the second current sensor is mounted at a second position of the device connecting line in the area to be detected, the second current sensor is configured to detect second current data at the second position of the device connecting line in the area to be detected, and the first position and the second position are respectively located on two sides of the area to be detected.

19. The control method according to 16, wherein the alarm apparatus comprises a light alarm apparatus, and the light alarm apparatus is configured to output light with different attributes according to the current state of the area to be detected.

20. The control method according to claim 16, wherein:
the current state of the area to be detected is an accessible state or an inaccessible state; and
the alarm apparatus further comprises a sound and light alarm apparatus, and the sound and light alarm apparatus is configured to output a sound and light alarm signal when:
the area to be detected is in an inaccessible state, and
the door lock device is triggered or a person is detected in a limited area of the area to be detected.
